(19) United States
(12) Patent Application Publication
(10) Pub. No.: US 2018/0204172 A1
(43) Pub. Date: Jul. 19, 2018

(54) INVENTORY MANAGEMENT SYSTEM

(71) Applicant: Mohammad Sabuz, Woodside, NY (US)

(72) Inventor: Mohammad Sabuz, Woodside, NY (US)

(21) Appl. No.: 15/871,457

(22) Filed: Jan. 15, 2018

Related U.S. Application Data
(60) Provisional application No. 62/446,555, filed on Jan. 16, 2017.

(51) Int. Cl. G06Q 10/08

(52) U.S. Cl. CPC G06Q 10/087; G06Q 10/0835; G06Q 10/0838

(57) ABSTRACT

An inventory management system is provided. The system includes one or more computing devices coupled to a database retrievably storing a map image of one or more three-dimensional sales floors and a plurality of inventory items, each inventory item physically located in three-dimensional space so as to form a multi-dimensional model of each sales floor and the physical location of each of inventory item that a user of the system. The system also provides a search module for identifying at least one matching item from the plurality of inventory items. The system provides a customer tracking module for identifying the physical location of each computing device on each multi-dimensional model. The system enables annotating portions of each multi-dimensional model into gender specific portions of each sales floor for determining the gender of the user of each computing device of forecasting the inventory management.

### CROSS-REFERENCE TO RELATED APPLICATION

This application claims the benefit of priority of U.S. provisional application No. 62/446,555, filed 16 Jan. 2017, the contents of which are herein incorporated by reference.

### FIELD OF THE INVENTION

The present invention is generally related to computer implemented methods, processes, systems, computer program product, devices directed to a combination inventory management and point of sale system.

### BACKGROUND OF THE INVENTION

Most retailers use some sort of security device on each piece of clothing to reduce thefts such as RFID tags. It is said that US businesses are losing $60 Billion annually due to thefts. Without an inventory system, it is nearly impossible to know what is stolen. With an inventory system, it reduces some risks but the problem still exists. Using cameras, security guards are good tools but thefts are still taking place daily. In addition, retail, grocery stores, corporate offices also fail to adequately track and inventory their goods and/or assets. Further still, there is a need for a system (along with its components) that would enable analysis of customer, employee behavior and the provision of services based on the collected and analyzed data. As such, there is a need for an improved inventory system that meets all the aforementioned needs and resolves the above discussed problem(s).

Currently there are inventory systems and Point of Sale (POS) systems which are used by Retail industries. The job of a typical inventory management system is to keep the count of inventory so management is alerted when it needs to be replenished or if there are too many items in the inventory. However, this is not the case in most inventory management systems. The inventories are not updated live, there is no way of tracking where each item is, items go missing and no way of finding out where each item is. Another issue is that many people go to shop for clothing but they simply cannot find the item they saw online or they are unable to obtain detailed information about a product (as most Sales Associates do not have the knowledge), which makes customers' shopping experience that much more difficult.

Retailers also change the location where each item is and for the customer who has not been to the store in a while, it makes it that much more difficult for such a customer to find the department and the right items. Further still, another major issue with current inventory management systems is that these retailers are not able to distinguish the gender of their customer while being unable to find out their customers' track history. As such, there is a need for a robust inventory management system that addresses all of the failings of previous and current inventory management systems as discussed above.

Aspects of embodiments of the present invention contemplate the use of modules and special codes which combine Inventory and POS systems together to show live results of inventory count, sales, data analytics for which items are selling most and when to order more inventories, and much more.

### SUMMARY OF THE INVENTION

Aspects of embodiment of the present invention contemplate computer implemented method(s), process(es), system(s), computer program product, device(s) directed to an inventory and point of sale (POS) system for enabling operation of any one or more of the following modules of the inventory and POS system: bar code module, RFID detection module, cost tracking module, custom pricing module, buying habits module, customer tracking module, gender determination module, application (app) download module, inventory forecasting module, inventory management module, inventory overview module, inventory tracking module, manufacturing management module, marketing/Advertising module, multi-location/single location module, online retailer module, order/re-order module, product details module, product/inventory report module, search/filter module, shipping & warehouse management module. In an aspect of an embodiment of the present invention, the overall operation is controlled by a central server.

In one aspect of the present invention, a computer implemented method of inventory management includes providing one or more computing devices coupled to a database retrievably storing a plurality of inventory items and a map image of one or more three-dimensional sales floors; each inventory item associated with tracking data for physically locating each inventory item in three-dimensional space; forming, by a blueprint module of the one or more computing devices, a multi-dimensional model of each sales floor and the physical location of each of the plurality of inventory item circumscribed by each sales floor; and providing, by the one or more computing devices, a search module for identifying at least one matching item from the plurality of inventory items, wherein the search module prompts the blueprint module to identify the physical location of each of the at least one matching item on each multi-dimensional model.

In another aspect of the present invention, providing one or more computing devices coupled to a database retrievably storing a plurality of inventory items and a map image of one or more three-dimensional sales floors; each inventory item associated with tracking data for physically locating each inventory item in three-dimensional space; forming, by a blueprint module of the one or more computing devices, a multi-dimensional model of each sales floor and the physical location of each of the plurality of inventory item circumscribed by each sales floor; providing, by the one or more computing devices, a customer tracking module for identifying the physical location of each computing device on each multi-dimensional model; and annotating portions of each multi-dimensional model two or more different classifications for classifying a user of each computing device as a function of the time their respective computing device is physically located within the differently annotated portions.

These and other features, aspects and advantages of the present invention will become better understood with reference to the following drawings, description, and claims.

An aspect of an embodiment of the present invention contemplates computer implemented method(s), process(es), system(s), computer program product, device(s) of claim 1, wherein operation of the bar code module, as enabled by the computer implemented method(s), process(es), system(s), computer program product, device(s) includes the steps of enabling the scanning of items and saving the scanned information in a database.

An aspect of an embodiment of the present invention contemplates computer implemented method(s), process(es), system(s), computer program product, device(s) of claim 1, wherein operation of the RFID detection module, as enabled by the computer implemented method(s), process(es), system(s), computer program product, device(s) includes the steps of enabling the scanning of RFID tags of items and saving the scanned information in a database.

An aspect of an embodiment of the present invention contemplates computer implemented method(s), process(es), system(s), computer program product, device(s) of claim 1, wherein operation of the cost tracking module, as enabled by the computer implemented method(s), process(es), system(s), computer program product, device(s) includes the steps of using historical data to determine the actual cost of an item.

An aspect of an embodiment of the present invention contemplates computer implemented method(s), process(es), system(s), computer program product, device(s) of claim 1, wherein operation of the custom pricing module, as enabled by the computer implemented method(s), process(es), system(s), computer program product, device(s) includes the steps of using discounts, promotions and other means to increase sales.

An aspect of an embodiment of the present invention contemplates computer implemented method(s), process(es), system(s), computer program product, device(s) of claim 1, wherein operation of the buying habits module, as enabled by the computer implemented method(s), process(es), system(s), computer program product, device(s) includes the steps of analyzing customer buying habits and presenting same to management.

An aspect of an embodiment of the present invention contemplates computer implemented method(s), process(es), system(s), computer program product, device(s) of claim 1, wherein operation of the customer tracking module as enabled by the computer implemented method(s), process(es), system(s), computer program product, device(s) includes the steps of using a customer's electronic device's MAC address (or similar address), determining the locations visited by the customer, recording the customer's buying habits, and deducing data from the customer's buying habits.

An aspect of an embodiment of the present invention contemplates computer implemented method(s), process(es), system(s), computer program product, device(s) of claim 1, wherein operation of the gender determination module as enabled by the computer implemented method(s), process(es), system(s), computer program product, device(s) includes the steps of tracking a customer, determining locations visited by the customer, pinpointing the customer, determine the customer's purchasing habits, analyze all collected data, and determine the customer's gender based on same.

An aspect of an embodiment of the present invention contemplates computer implemented method(s), process(es), system(s), computer program product, device(s) of claim 1, wherein operation of application (app) download module as enabled by the computer implemented method(s), process(es), system(s), computer program product, device(s) includes the steps of enabling download, to a local device, of a mobile app used for the inventory & POS system.

An aspect of an embodiment of the present invention contemplates computer implemented method(s), process(es), system(s), computer program product, device(s) of claim 1, wherein operation of the inventory forecasting module as enabled by the computer implemented method(s), process(es), system(s), computer program product, device(s) includes the steps of using historical data to analyze and forecast inventory needs.

An aspect of an embodiment of the present invention contemplates computer implemented method(s), process(es), system(s), computer program product, device(s) of claim 1, wherein operation of the inventory management module as enabled by the computer implemented method(s), process(es), system(s), computer program product, device(s) includes the step of determining the location of an inventory item using store associate input.

An aspect of an embodiment of the present invention contemplates computer implemented method(s), process(es), system(s), computer program product, device(s) of claim 1, wherein operation of the inventory overview module as enabled by the computer implemented method(s), process(es), system(s), computer program product, device(s) includes the step of enabling the viewing of inventory over a centralized system from any portal within the system.

An aspect of an embodiment of the present invention contemplates computer implemented method(s), process(es), system(s), computer program product, device(s) of claim 1, wherein operation of the inventory tracking module as enabled by the computer implemented method(s), process(es), system(s), computer program product, device(s) includes the step of using RFIDs, GPS, a location's floor plan or blueprint to track and pinpoint the location of an inventory item.

An aspect of an embodiment of the present invention contemplates computer implemented method(s), process(es), system(s), computer program product, device(s) of claim 1, wherein operation of the manufacturing management module as enabled by the computer implemented method(s), process(es), system(s), computer program product, device(s) includes the steps of setting specifics as to when new inventories are needed and tracking the inventory level of manufacturers' clients.

An aspect of an embodiment of the present invention contemplates computer implemented method(s), process(es), system(s), computer program product, device(s) of claim 1, wherein operation of the marketing/Advertising module as enabled by the computer implemented method(s), process(es), system(s), computer program product, device(s) includes the steps of enabling customer communication, purchase or repurchase of items directly through a vendor's site and scheduling alerts when inventory is decreasing.

An aspect of an embodiment of the present invention contemplates computer implemented method(s), process(es), system(s), computer program product, device(s) of claim 1, wherein operation of the multi-location/single location module as enabled by the computer implemented method(s), process(es), system(s), computer program product, device(s) includes the steps of generating live inventory status updates across multiple locations.

An aspect of an embodiment of the present invention contemplates computer implemented method(s), process(es), system(s), computer program product, device(s) of claim 1, wherein operation of the online retailer module as enabled by the computer implemented method(s), process(es), system(s), computer program product, device(s) includes the step of managing online purchases and in-person purchases.

An aspect of an embodiment of the present invention contemplates computer implemented method(s), process(es), system(s), computer program product, device(s) of claim 1, wherein operation of the order/re-order module as enabled by the computer implemented method(s), process(es), system(s), computer program product, device(s) includes the steps of replenishing inventory sooner than expected or pushing back the date of delivery of an inventory item.

An aspect of an embodiment of the present invention contemplates computer implemented method(s), process(es), system(s), computer program product, device(s) of claim 1, wherein operation of the product details module as enabled by the computer implemented method(s), process(es), system(s), computer program product, device(s) includes the steps of enabling a customer with the ability to alert a store associate for help with an item, locating the customer using the store's WiFi, floor plan and/or MAC Id, linking the store associate's name tag using a GPS tag.

An aspect of an embodiment of the present invention contemplates computer implemented method(s), process(es), system(s), computer program product, device(s) of claim 1, wherein operation of the product/inventory report module as enabled by the computer implemented method(s), process(es), system(s), computer program product, device(s) includes the steps of providing real-time inventory information, inventory reports, and up to date details regarding products.

An aspect of an embodiment of the present invention contemplates computer implemented method(s), process(es), system(s), computer program product, device(s) of claim 1, wherein operation of the search/filter module as enabled by the computer implemented method(s), process(es), system(s), computer program product, device(s) includes the steps of providing access to the system, searching the system for particular item(s), and enabling the filtering of the search results.

An aspect of an embodiment of the present invention contemplates computer implemented method(s), process(es), system(s), computer program product, device(s) of claim 1, wherein operation of the shipping & warehouse management module as enabled by the computer implemented method(s), process(es), system(s), computer program product, device(s) includes the steps of tracking incoming and outgoing inventory item(s) to and from the warehouse.

Aspects of embodiments of the present invention contemplate the use of modules and special codes which combine Inventory and POS systems together to show live results of inventory count, sales, data analytics for which items are selling most and when to order more inventories, and much more.

### BRIEF DESCRIPTION OF THE DRAWINGS

FIG. 1 is a user interface schematic view of an exemplary embodiment of a map image of the present invention; and

FIGS. 2-5 are flow charts of an exemplary embodiment of the present invention.

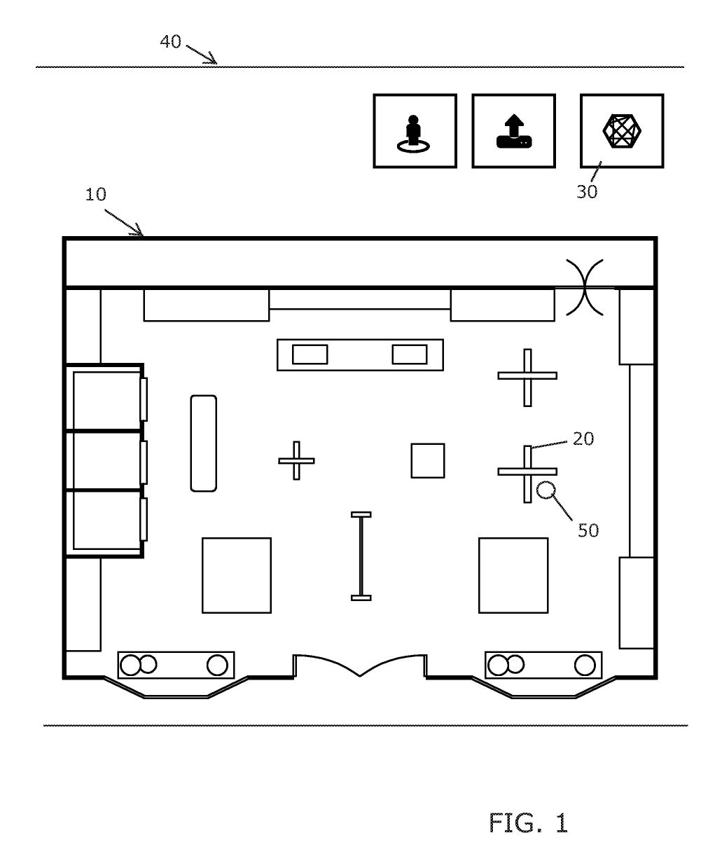

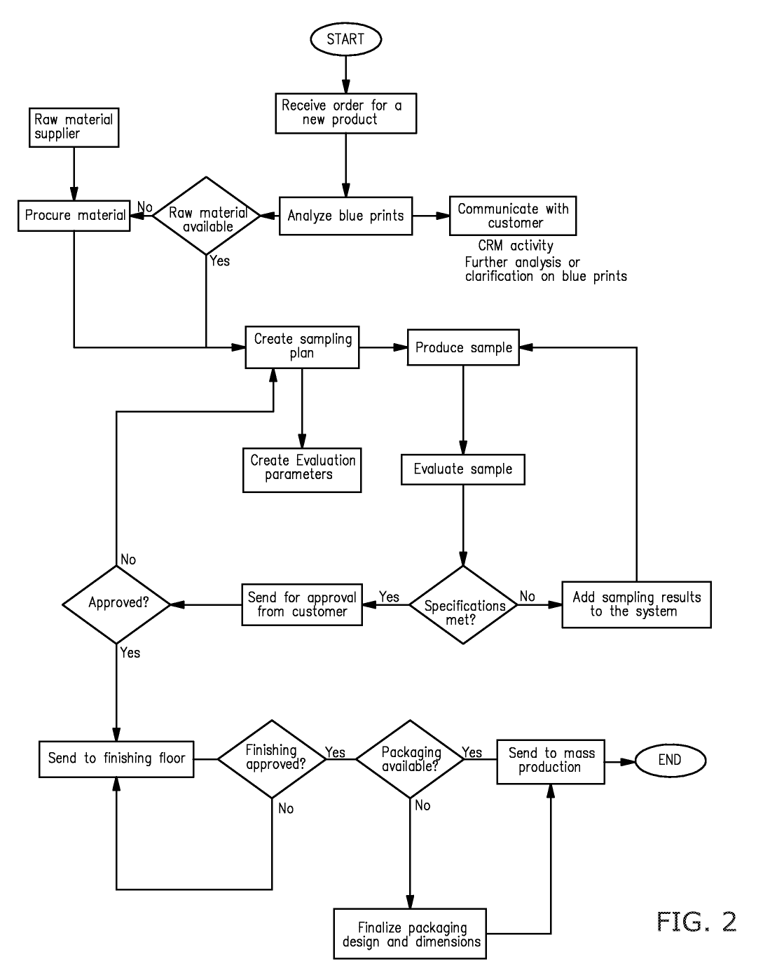

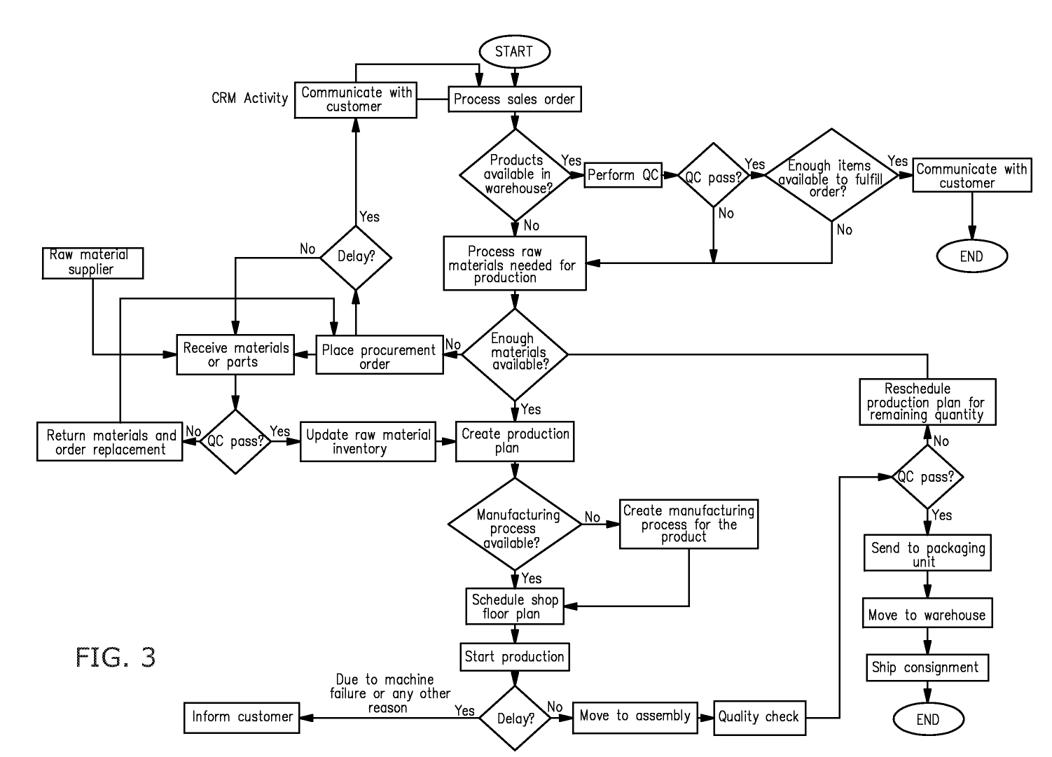

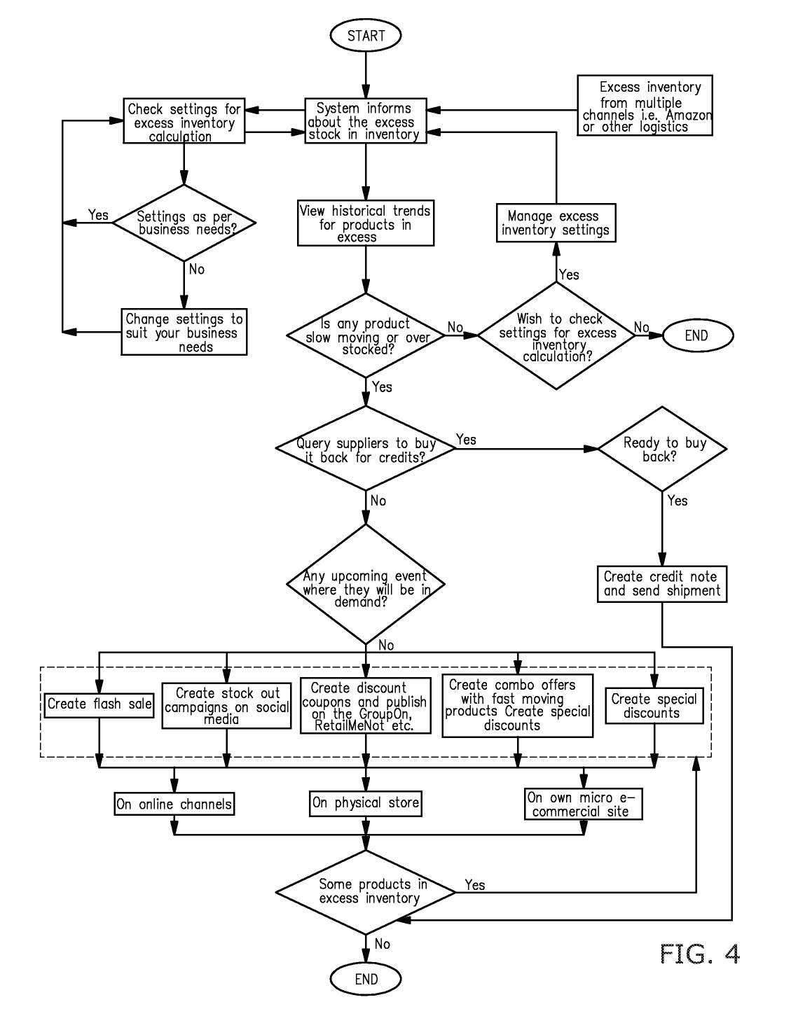

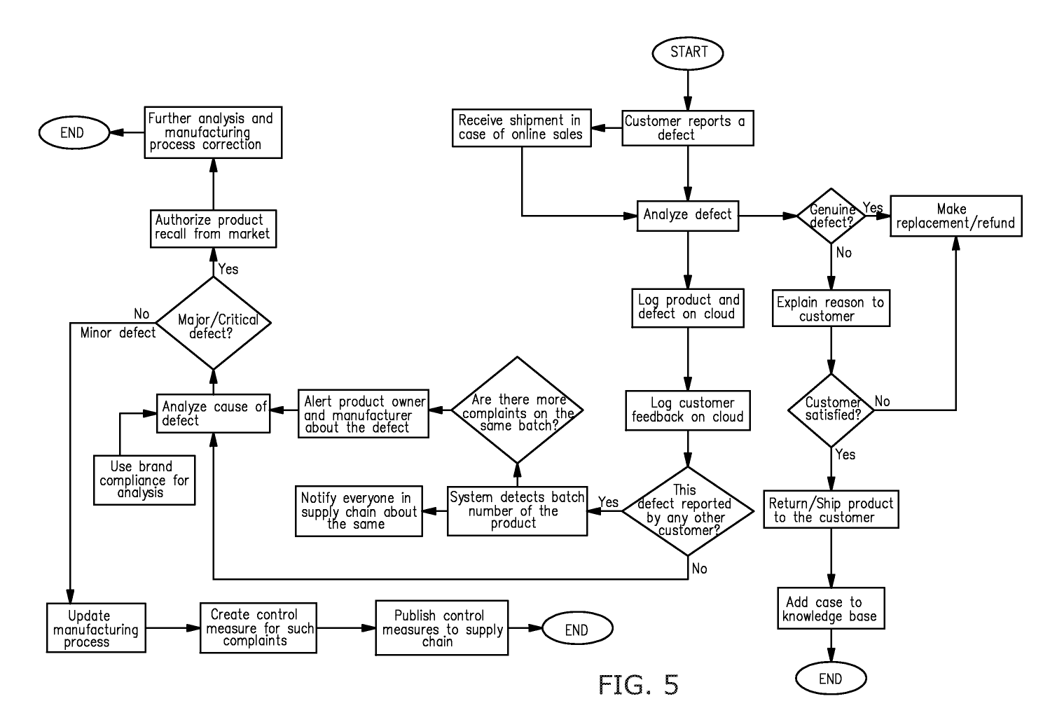

The inventory module of the software may be linked with the manufacturer so the manufacturer can follow up with the retail industries, instead of the other way around. Aspects of embodiments of the present invention contemplate updating inventories live, in which case, if the register indicates that there are 5 items left, there will be 5 items left in inventory—no more missing or lost items. Aspects of embodiments of the present invention contemplate having the inventory system linked with the RFID tags which will have a tracking software tool installed. Using such a system, store managers and associates will always know where an item is. Conventionally, an item of clothing is brought down to the sales floor and if the customer doesn't purchase the clothing, it somehow ends up somewhere else and no way of telling where it is. With the present invention, before an item is taken out of the inventory room, the associate will be asked to scan the item (even though not required), after it has been brought to the sales floor. If the customer purchases it, great. If not, the item will be trackable regardless of where it ends up. If another customer looking to purchase the item, with a quick search in the system as contemplated in the present invention, the associate will be able to track where the item's location on the sales floor. The system will have a blueprint of the store (previously uploaded, in one aspect) and therefore, no items will be ever lost or misplaced.

Aspects of embodiments of the present invention contemplate the accumulation and production of data analytics. These analytics will definitely be for which items are selling the most, at what point in time, and so forth, an added value will be with the store's Wi-Fi systems. Wi-Fi is available everywhere nowadays even in the train station. For instance, let's say “Jon” walks into Macy's at 34th St. He has his phone with him, the stores Wi-Fi will be able to track which item he is purchasing, which areas he is traveling to throughout the stores and so forth. This is attainable with the simple use of a MAC address, which registers when using the Wi-Fi. Each electronic device has a MAC address (similar to Social Security) or similar digital address, which is unique to each device, no two devices will have the same MAC address. The store management, and corporate offices will be able to tell who is visiting their store, how often, their purchasing habits and much more. Since most stores are divided among male and female gender clothing, the management, over time, will be able to say whether a MAC address belongs to a male or female gender. These data are priceless and marketing department can create targeted campaign based on these analytics.

Aspects of embodiments of the present invention contemplates using a location's Wi-Fi to track customer behavior rather than using sensors. In doing so, system(s) as implemented by use of computer implemented methods, processes, computer program product and/or devices can:

Connect with each electronic device the customer brings to the location by acquiring the Mac ID of those devices

Save the Mac ID of the device for future use to automatically connect to the Wi-Fi, next time the customer is at the location

If the location has a central data system where each of their location talks to each other, the customer's data will automatically be available throughout all locations

Track customer history

Track customer buying habits

Track the number of times the customer visits the locations and which location they are walking through

Determine if the customer is male or female

Exemplary aspects, components and operations of the contemplated invention as discussed below:

Barcode Module

Barcodes are used at locations to scan items and determine the price and number of inventories left of that item, but most of the time the inventory is not updated accurately to reflect the correct number of items available. Aspects of embodiments of the present invention contemplate the use of computer implemented methods, processes, system(s), computer program product and/or devices in enabling/effecting the updating of all items automatically so the correct number of items left at any given moment may be reflected. In one aspect of an embodiment of the present invention, all locations (of a specific company) will have a centralized server, thereby enabling the inventory to be updated throughout including the e-commerce site of the location; if someone was ordering an item online, the buyer would know whether an item is available for purchase at the beginning not during check-out. “Location” may include, without limitation, retail stores, corporate offices, hospitals, etc.

Blue-Print of the Location & RFID Module

Radio Frequency Identification (RFID) tags are used as a security tool, which may be used to activate an alarm at the entrances of locations should someone try to steal an item having an RFID tag attached. In other situations, should the individual try to take the RFID tag off, it would release some ink thereby making it easier for security to catch the thief when trying to leave the location.

Aspects of embodiments of the present invention contemplate the use of a mini-GPS tool to track each individual item as customers does not always leave the item where they initially took it from and it may be assumed lost/stolen if not found.

Aspects of embodiments of the present invention contemplate the use of computer implemented methods, processes, system(s), computer program product and/or devices in enabling/effecting the combining of the RFID location information and beaming data with the blue print of the location (which will be installed in the system), employees will be able to pinpoint exactly where an item is at any given moment. If a customer is looking for a specific size of item “X”, it can be quickly tracked to see where it is within the location.

Cost Tracking Module

Price of items goes up and down which reflects profit margins to fluctuate. There is much that may be gleaned from historical data along with everything else in consideration in order to determine the actual cost of an item and make strategic decisions for business growth. Aspects of embodiments of the present invention contemplate the use of computer implemented methods, processes, system(s), computer program product and/or devices in the system will analyze all of said data points in proposing a retail price. Costs to take in consideration may include but are not limited to:

Manufacturer costs

Shipping costs

Import & export costs

Rent of the location and utilities

Employee wage

Custom Pricing Models Module

As the weekend or holiday season arrives, there tends to be special discounts, promotions, and other offers available to increase sales and more inventory turnover. Aspects of embodiments of the present invention contemplate the use of computer implemented methods, processes, system(s), computer program product and/or devices in creating a plan and enable their entry into the system with specific date/time range so it automatically updates without creating any extra work.

Customer Buying Habits Module

Customers are always shopping for the next thing, whether it's at your location or at another. Understanding the demand and preference of a store's customers for the store's location and having enough inventory to serve them can make or break the store's business. Aspects of embodiments of the present invention contemplate the use of computer implemented methods, processes, system(s), computer program product and/or devices in analyzing these buying habits and present them to management in order for them to make executive decisions.

Customer Tracking Module

With the help of a location's Wi-Fi, customer's electronic device MAC address (or similar address for non-Apple devices), and the location's blue-print, the system will be able to determine, exactly how many times a customer has been to the location, which location they've traveled through, how long they were at a specific location of the location, the items they were browsing through, and buying/spending patterns. This is will be achieved by computer implemented methods, processes, system(s), computer program product and/or devices used and operated in the system. In one aspect, the system will analyze and combine all the data and provide a detailed report.

Define Gender Module

By taking all the data found in Customer tracking and combining it with the blue-print of the location the application will be able to analyze the data furthermore and ultimately determine the gender of the customer.

Aspects of embodiments of the present invention contemplate the use of computer implemented methods, processes, system(s), computer program product and/or devices in enabling/effecting the upload a location's (e.g. a store) blueprint. With the connection by device(s) and/or system(s), contemplated by aspects of embodiments of the present invention, with the store's Wi-Fi it can: pinpoint a customer, pinpoint the locations the customers are traveling through within the store, determine the customer's purchasing habits, and ultimately determine whether the customer is a male or female. In one aspect, the system(s) as contemplated by the present invention, can distinguish the sex of the person by knowing where each POS/sales register are located throughout the store.

Another added feature we will add will be directly on the POS system, it will say “Male”, “Female”, or “Family”, which the sales associate will simply select based on the person/people who is there shopping. Knowing the gender of a customer is just as important as knowing which locations they've traveled through to gather all items. Combining these features, will give the ultimate advantage for business growth.

App Download Module

Once the application (“app”) as contemplated in the present invention is downloaded, customers can walk in a location and track items that maybe they saw on the retailer's website and see if the retailer has the item in location (or not), it will basically act as a virtual sales representative and will educate the customer on the product. Customers can also download the mobile app once they enter the location to navigate through the location and obtain this information about products as well, as if they were shopping online (and see if an item they viewed online is also being sold in the location, in which case, the app will direct them to where it can be found). Customers can watch videos that the retailer can upload to also support the sales process and provide an amazing customer experience.

Inventory Forecasting Module

Based on historical data, the system using, computer implemented methods, processes, system(s), computer program product and/or devices will analyze and forecast how much inventory may be needed in the coming days, weeks, months, and years. Based on this result, the management can make better business decisions and work with manufacturer accordingly.

Inventory Management Module

All locations can be expected to carry inventories of a particular product at any given moment. One location may have one while another location carries another inventory item. It may be that the item is needed at one location but is sitting in another location where customers are not interested in the item. In an aspect of an embodiment of the present invention, the contemplated system will be able to analyze these by the number of inquiries made at a certain location vs. another. The sales associate will enter in the system whenever an inquiry is made for an item or if there are none left at the location. Analyzation of these will provide management the necessary information needed to better structure their inventory and products to sell.

Implementation of the contemplated system in grocery stores, will include setting expiration dates, so that expired items are not sitting in the store (which is a health code violation). Implementation of the contemplated system in corporate offices will also help ensure that all inventory will be accounted for. Many times, employees utilize office materials for personal reasons such as stamps for personal use, taking notebooks, pen, paper, etc. home. When it is an office of 5 people it's not expensive, but when it is a corporation of 100, 500, 1000, or 100,000+ employees, the numbers quickly add up and it affects the company's bottom line. In many corporations, employees are given a code for using the printer, similarly, when an employee needs paper, pen, and other supplies. Implementation of the contemplated system in corporate offices will require that they will enter their code to retrieve the item. This will allow companies to keep track of all items.

In hotels, the inventories will be accounted for and tracked. When hotel inventory (e.g. towels and toiletries) are stolen, hotels typically account for them by automatically charging the room's occupants. The cost may also be built in to the nightly rate. There are no real inventory systems, most supplies are simply sitting in an unguarded room, where, anyone (if wanted) can go and take it. Implementation of the contemplated system here would help address these problems.

In hospitals, all inventory will be accounted for and linked together, as well as expiration dates. Hospitals have different departments and different buildings, by having a centralized inventory system items can be quickly located so if there are ever a time when an item may be needed, it can be quickly located (which can save someone's life).

Inventory Overview Module

Whether a store has one location or multiple locations, all inventories, using the contemplated invention, will be centralized so if there is a lack of an item at one location, they can view the inventory of another location and if needed, they can request for it to be shipped to them or advice the customer to go there. The location will also be able to put a hold on the item on behalf of the customer so when the customer is at the other location, they are not told, the item is gone.

Inventory Tracking Module

Implementation of the contemplated system will enable all inventories to be tracked live using RFIDs, GPS, and the location's blue-print. Utilization of these tools makes it easier to track and find items, which will reduce thefts and loss of products. As every piece of item is tracked, shoplifters will be caught easily and all items will be accounted for. If a product is at different floor or a different section than it should be, it can be easily tracked and put back in the right place. Sales associates can run a report that will say specifically where each of these items are and where they each should go. Implementation of the contemplated system will also enable inventory to be automatically updated as the items are being sold. This would engender the following advantages:

No more waiting for someone to count inventory at the end of the night

No more uncounted or lost inventory

No more unhappy customers because all items have been accounted for and

knowing precisely how many items are available

Manufacturer Management Module

Small, mid, or large locations, may carry similar and/or different types of products. They each may have one or multiple manufacturer, while some may have their own manufacturing company; regardless of the situation, being aligned with the manufacturer can make everyone's job that much easier. Implementation of the contemplated system, using computer implemented methods, processes, system(s), computer program product and/or devices, enables management team can set specifics as to when new inventories are needed. The manufacturer can track the inventory level of their clients and they can ship the products accordingly. If needed, they can contact the person in charge of inventory.

Marketing/Ad Module

Application will feature companies like Staples, Starbucks, etc. where companies can restock and order seamlessly through our system. Our clients will be able to communicate with, purchase or repurchase items directly through the vendor's or location's site with their designated vendors to replenish their inventory or business supplies. Implementation of the contemplated system, using computer implemented methods, processes, system(s), computer program product and/or devices, enables clients to pull reports and manage their budgets more efficiently. Clients can also schedule alerts when inventory of items as they are decreasing or close to being empty. Automatic orders can also be created. Implementation of the contemplated system would engender the following marketing advantages:

Enable advertisers and marketing to use data/info collected to target market

Save money, time and effort to better target its audience and receive better results

Multi-Location or Single Location Module

Businesses expand all the time and with it so do their locations. Implementation of the contemplated system, using computer implemented methods, processes, system(s), computer program product and/or devices, enables the business to be centrally connected to all locations and enable receipt of live updates which would help management make executive decisions faster and accurately.

Online Retailer Module

When it comes to inventory when customers order on a retailers site and returns items. Implementation of the contemplated system, using computer implemented methods, processes, system(s), computer program product and/or devices, enables online retailers to get a better handle on their inventory when it comes to online purchases (as well as in-location). When a customer purchases an item and later decides to return it, it will ensure that the item is tracked, reported, and noted as a return item, enabling the item to then be restocked within the retailers' inventory.

Order/Re-Order Management Module

Having direct connection with the manufacturer, if a location needs to replenish their inventory sooner than expected or push back the delivery date, they can simply change it in the system and the manufacturer will get the update and ship accordingly.

Product Details Module

Many times, the sales associates have no idea about the product they are selling but as customers, before purchasing something, we want some details about the product. Taking that into consideration, as customer travels through the location, the location's Wi-Fi will be able to locate the customer with MAC id, and blue print of the location and based on that where ever they are, they will get alerts about the product, product descriptions, sales/promotions, etc. If they need more help and the sales associate is not present, the customer can tap on their electronic device requesting for an associate. The associate whoever is near the customer will be alerted to help the customer.

The associate usually wears a name tag, the name tag will have GPS and will be linked with the Wi-Fi. Each name tag will be unique as they each will have a MAC id. The name tag will automatically shut off when they are on their break or not working. This will be determined by clocking in & out.

Product/Inventory Report Module

Implementation of the contemplated system, using computer implemented methods, processes, system(s), computer program product and/or devices, enables employees to receive real time accurate information with picture of products in the system to better educate their customers. Implementation of the contemplated system, using computer implemented methods, processes, system(s), computer program product and/or devices, enables customers to receive reports of their inventory or office supplies with pictures and any customizable information they would like to receive. This also applies to retailers where the contemplated system can, in in real-time, provide information to customers with a picture and up-to-date details about their products thus assisting in both sales and customer service.

Search/Filter Module

Implementation of the contemplated system, using computer implemented methods, processes, system(s), computer program product and/or devices, enables the sales associate, management, and others (that the management allows) to have access to the inventory. Other than tracking items there will also be an option to search and filter items of inventory. Let's say a customer comes to the location, they are looking for a “V Neck t-shirt” and doesn't have any brand in mind. We can search for “V Neck” and get all the results for the customer, we can narrow it down more based on price, brands, etc. and can help the customer accordingly. The associate, can search only at the local location or for all the location based on what the customer is looking for.

Shipping & Warehouse Management Module

Whenever a manufacturer sends inventory or a warehouse/location ships an item to a customer or to another location, there will be a domino (pizza) tracking system for every step of the way. This way one can track exactly where each item is and exactly where it is at any given moment.

The present invention is a solution for entire supply chain from managing day to day operations to selling goods to customers. The present invention keeps customer as the pivot to drive the supply chain. The present invention intends to connect all the entities in the supply chain by a single cloud based software system, with growing business and better customer service as the primary objective.

The present invention is adapted to provide the following: time inventory and stock analysis; real time inventory track using I Beacons/RFIDs; unified portal for multi-channel selling; personalized customer service; e-commerce portal for retailers; dedicated apps for dedicated roles; customer feedback visibility across supply chain; and “online onsite” shopping for customers.

A retailer is the face of any supply chain. An average retailer would typically face a lot of traffic of products and customer both. A good software solution is a need of every retailer where he can manage all his traffic and analyze business needs and expenses. Meeting customer demand is a key to success in every business. This solution provides intelligent forecasts based upon history and trends which help retailers to identify what they need in coming days.

The present invention provides dashboards providing various figures which a retailer needs through the following interfaces/dashboards: the number of orders and total value of orders, followed by a glimpse on inventory; how many products a retailer has, how many are going on low stock and how many are stuck on the shelf; “Sales Trend” which is a visual representation of how sales are performing on various channels; “Sales Activity”, providing a glimpse of actionable which help the retailer in fulfilling the orders; and “Marketing Campaigns”, showing how online marketing campaigns are doing.

The present invention also provides forecasting modules for assisting a retailer manage his stock through providing graphical representations of how many items are running low, how many are about to reach their shelf life and how much is the deficit forecast value. Inventory summary shows how much stock is coming and how much warehouse capacity retailer has left. Warehouse capacity information will be available only if the retailer has purchased the warehouse management module. This information helps the retailer to plan future purchases. The forecasting modules may also list items which maybe low according to forecast. Forecasting will take several parameters into account such as sales, seasons, customer gender, festivals and holidays and more. These parameters are configurable by the retailer and he can choose his own parameters for calculating forecast from the configuration settings module. Another graphical representation may be the health forecast, which shows a list of products which are nearing their self-life. In the last column of each row there is a link to create offer, where a retailer can create offers or campaigns to quickly sell these products out. Data shown in this table is configurable from the configuration settings screen.

Overstocking items is a plague to any business, it is not only a blocked money but it also keeps draining money. The present invention can identify which items are stuck for a long time or which may have a tendency to get stuck. The present invention summarizes excess inventory on Online Channels (amazon, eBay, Etsy etc.), Amazon FBA (Fulfilled by Amazon) i.e. if the logistics is done by amazon, and in physical stores. The present invention provides graphical representation of excess inventory list supported by additional data such as average sale and the storage cost. Note: the storage cost is provided by warehouse management module. Logic of excess inventory can vary from business to business, therefore, it is configurable in settings. Creating campaigns enable retailer to create online campaigns for quickly clearing stock.

Today most businesses are already online or they are going online. Selling on multiple channels is a common practice in the internet age. Fancy it may seem, but is never easy for a retailer to manage so many channels, especially inventory. The present invention provides an integrated environment for all channels. Retailers can manage inventory on all channels such as Amazon, eBay etc., view and process orders from one portal. System will be integrated with APIs which will communicate with online channels.

The present invention may provide a stock allocation process from incoming shipments. The present invention may provide user interface representations displaying the inventory status number of units in store, in warehouse, total received units from buyers (pending allocation) and in process, warehouse capacity, etc. as general figures.

The present invention may provide user interface representations displaying the list of incoming shipments in a detailed format. Received units can be allocated to various channels at this stage show in the figure on such representations. If the shipment status is “Received”, then the received stock goes through verification process. Retailer can define a set of check list which needs to be, followed once stock is received. This can be set in the settings screen, as every business can have a different process. Any damage, loss, incorrect item can be recorded at this stage. If the items need to be returned, they can be sent back by raising a shipping request. The same will be notified to the supplier.

Having an online shop is surely worth in this age, however, it does involve new costs and management overhead. The present invention provides a 2-step process to create an online shop. No management overhead, no technical skills needed, and one can create an online shop in less than an hour. The present invention may provide a template selection step. Here a retailer can choose a template from a set of predefined templates. Next step is where the retailer can choose his categories and products which he wants to sell. These categories and products are already managed in the system as part of catalogue management module. Online store will be ready after this step. Customers will be able to shop from this store via a mobile software application.

The present invention provides an integration with social media which allows retailers to track their customers and followers from one platform. Creating new offers, promoting new products can never be easier. Create an offer or a marketing campaign and publish on multiple channels from within our solution. Once on, retailers can track their campaigns performance from within this solution.

The present invention may provide a marketing dashboard for a retailer. This dashboard may be an amalgamation of various online channels and media. Retailer can view or create marketing campaigns from within this solution. This dashboard may be integrated with major social media channels, enabling a retailer to manage all of them from one place. The dashboard also shows performance of marketing campaigns and reflects the direct result of campaigns.

A retailer system cannot be complete without having a POS associated with itself. POS offered by the present invention based, self-aware POS. The POS interface configures itself according to the number of products a retailer has. It is available in 3 modes small (up to 25 products), medium (about 25-100 products) and large scale (over 100 products). These modes provide easy UI and UX suitable for making quick bills and serving customers faster. POS will be integrated with Barcode and QR code scanner.

In a typical supply chain, customers buy from retailers, except very rare cases. This solution gives customers a unique shopping experience whether online or offline. Customers can shop online from any store near them or far away. The present invention gives a navigation system guiding customers to the store. Customers can use a feature “Around Me” which will show what stores are available around them. They will also see if these stores are offering any promotions or new launching a new product or series. This feature can be used by retail stores to promote various products and even their stores. Additionally, promotions can be customized to suit individual customers.

On the other hand, customers can buy from these stores online if the store has opted for a mini online store. Clicking the shop online button will take the customer to retailer's online store. Customers can find location of items they are looking for within a store by using in store navigation in the present invention. When inside a store if a customer is not able to get complete information about the product, they can switch to the present invention and see full specifications about the product. The present invention detects customer's location and displays the location of the item being searched.

Customers can even order online and pickup from store at a convenient time. The present invention allows customers to buy from just one store or from multiple stores at the same time. Another powerful feature for customers is the search module. The search module may work with natural language search algorithm i.e. customers can use simple English to search stores, items offers or anything within the scope of the application. The searched item may be at least one of a plurality of inventory items 50. Every time a customer's searches for a product via the search module, the customer may be provided with a list through the search module of matching items available in a database of inventory items 50.

The search functionality may include captured image searching. Captured image searching enables the search for matching items of inventory items 50 based on captured images. The captured image may be a captured image that was imported, exported, retrieved from memory, or generated via the image capturing functions (camera, for example) of the relevant computing device engaging in the search, employing the search module. So, by way of example, a user may capture an image of an article of clothing being worn by a passerby, and then use the search modality to search for a matching item of that article of clothing against associated databases of inventory items 50. It being understood that the scope of the search functionality includes everything published.

The present invention enables customers to search for different stores registered on our application. Users can filter the list to get the preferred matching item, for example—filter for location, filter for rating, etc.

The present invention also proposes a unique combination of VR (Virtual Reality) and AR (Augmented Reality), allowing customers to take a virtual tour of stores and perform shopping. Through the present invention, a customer can virtually move into a sales floor of a store and can view products that store offers using the 360-degree view (This view will be made available to customers by store owners).

While virtually roaming around in the store (on our solution), users can also explore the products in the shelfs they are viewing. Just by tapping onto the shelf our solution will show user a list of all the products arranged/placed in that shelf or rack. Users can than buy these products or can then add them to their shopping cart.

The present invention may include a retailer module adapted to provide customers the VR (Virtual Reality) experience, our solution will allow Retailers to add 3-D view of their sales floor in their profile to generate a map image 10. After adding these map images retailers can set tags on them, which will help users to identify different sections of the store. Also, retailers can add list of products into these tags.

The present invention keeps a record of all purchases by a customer and provides analytics based upon their purchasing history and trends. Customers can keep a track on what they are spending on, which are their favorite stores, what products they shop most and much more.

Up next is another powerful feature, which allows manufacturers to connect directly with the customers or in other words, the present invention provides another platform for the manufacturers to connect customers. Whenever a manufacturer is about to launch a new product or wants to survey customers as part of the market research for a new product, this app allows manufacturer to post content directly to the customer. Content can be directed to relevant customer base or all customers which are linked to the present invention based upon customer buying habits. The present invention tracks clicks and likes and views of the content which help manufacturer decide what or how customers want their products. If customers like a product, they can pre-order from the app. The present invention may find nearest retailer or customer can choose a retailer from provided list. The present invention may also allow customers to book a demo or a preview at a nearest retailer, if there is a scheduled event, they can subscribe.

Dealers—Are the backbone of any supply chain. In typical supply chain are wholesaler, supplier, distributor and of course, dealer. These terms are often, if not always, used interchangeably. However, the primary responsibility remains the same, the supply. In general, dealers buy goods from manufacturers and are typically assigned a territory (area) to handle demand within that area. Dealers seldom engage with end customers; their primary focus is to supply goods to retailers. The present invention may provide a dashboard for a dealer which allows him to see most important information of business such as sales, purchases, payable, receivable and leads. The various dashboards show sales trend which is an aggregation from multiple sources such as local store, website sales, Amazon Business, Alibaba and other B2B sources (subject to availability). Leads are derived from local and online sources and aggregated into one Customer relationship management (CRM) tool. Total payable/receivable are shown in payment cycles. Most businesses make or receive payments in cycles i.e. weekly, fortnightly, monthly, every 10 days or any other custom period. This cycle can be defined in configuration settings.

In the present invention, dealers and retailers are connected on a single platform and stock can be viewed real time, of course if the retailer allows his stock to be viewed up the chain. The platform shows low stock products of the dealer himself, and contains a re-order link which allows dealer to place order immediately.

The present invention allows dealers to query other dealers for a product, this allows optimization in supply chain prevents unnecessary manufacturing request. Low stock for one dealer can be excess stock for another. The present invention may be configured to find a perfect match. If dealer has enough available stock, they can click on accept and a sales order will be generated.

Inventory is another important aspect for any business, especially for a supplier. The volumes are so high that it is easy for anyone to forget or lose control over their stock. This can be harmful for a business if a proper tracking system is not in place. Tracking inventory alone doesn't solve all the problems, system should be able to reconcile inventory and report correct statuses. The present invention may provide a inventory tracking page for a dealer. Inventory can be tracked at various levels such as location, warehouse. Location and warehouse filters will be available if a dealer has multiple locations and warehouse. Dealer can simply select a location and search for all low stock products, or lost products at that location. This screen is capable of answering most of the inventory related questions. Based upon the status of the products listed the action button is rendered. For example, if a product has low stock, dealers gets to re-order stock from this screen itself. If a product is excess stock, dealer gets an option to create campaigns to sell them out.

Other features of inventory management system include an inventory forecast and excess inventory screens which work the same way as for retailer, except for the difference that dealer direct customers are retailer and a dealer's supplier are other vendors and manufacturers.

Next step for retailer is to manage his sales and purchases. Let's look at purchases first. The present invention may provide a purchasing dashboard for dealer. The dashboard may contain stock and purchase related information at the top. Then a table of Request for Quotations. Here all the quotation requests made by the dealer are displayed. These requests can be sent to other dealers or manufacturers. This purchasing dashboard may only display some active ones, click of table will navigate to the entire list. Past due purchases display suppliers/manufacturers who are yet to complete a purchase order. The purchasing dashboard may display purchase orders by status and a list of new purchase order generated in the system.

Sales order management is a core function for any business. The present invention may provide an order management dashboard. The order management dashboard may display important aspects of sales order. Pie-chart shows sales orders by status. Top retailer list considers few factors to determine top retailers. Major factors are purchases, amount, payment cycle and retailer turnover.

Next up is shipping management. An integrated shipping system is important to handle shipments from various sources. Real time information of shipments allows businesses to serve customers better and gives a firm control on stock movement. A shipping dashboard may be integrated with shipping agencies such as USPS, FedEx etc. Dealer can choose which shipping carrier they use, and dashboard will configure itself to do the same. Carrier performance allows dealers to decide which carrier is performing better for them and can divert his shipments to best performing carrier.

The present invention may provide a full-fledged account and finance system. This system will be integrated with 3rd party APIs such as XERO or QuickBooks who already provide a reliable accounting system. Built on top of these APIs is our finance and accounting dashboard which is shown in the figure below.

Marketing system for a dealer is same as retailer. Marketing module is integrated with social media APIs such as Facebook, Twitter, YouTube. Creating new offers, promoting new products can never be easier. Create an offer or a marketing campaign and publish on multiple channels from within our solution. Once on, retailers can track their campaigns performance from within this solution.

Next up is Product Analysis. This is another important feature for any supplier or retailer. Product analysis allows dealers to view a product from multiple angles. It shows how a product has been selling and the trend of demand. Demand is calculated by orders received by dealers. This dashboard gives a 360-degree view of product performance. Insights of a product can help a dealer in creating campaigns and target specific audience for campaigns. Counts of views and reviews are aggregated from all retailers under a particular dealer. The present invention may be also equipped with a high-performance CRM which handles all customer activities from pre-sales to post-sales to customer service. Often dealers buy goods from other dealers. Often there are more than one dealers in the supply chain, especially for FMCG products. In such cases, managing vendors is a very important aspect for any business. A simple and intuitive vendor management module does the job for all dealers. A vendor's products, purchases and all past communication can be tracked at one place. This module helps building better relationships across the supply chain which is a key to success of any supply chain. If a vendor gets a new product, they will also be available in the vendor product list here. Shipments to and from a specific vendor can also be tracked here. Vendor profile provides 360-degree view of a vendor-dealer relationship. Dealers must be connected with their customers, which are typically retailers and sometimes other dealers. Solution provides a robust customer management module to help build a better relationship with customers. This module provides a complete management of customers and their sales analytics which can provide plenty of ideas to any dealer to grow his business.

Finally, all these modules have some settings which are configurable by business owners. Using these settings dealers can configure software to run as per their needs. Dealers can set notification alerts on certain events/states in the system.

The present invention may provide a blueprint module. The blueprint module may provide a database for storage, retrieval and display of at least one map image 10 and a plurality of store images 20. Each of map image 10 and store image 20 are two-dimensional images. Each map image 10 may be an electronic representation of a sales floor and warehouse. The sales floor and warehouse may or may not be physically adjacent to each other. Such as the sales floor of a retailer. Store images 20 may be photographic images taken from different points on a sales floor associated with a map image 10. The store images 20 may include, but not be limited to, shelves, racks, and other platforms for selling inventory items in three-dimensional space on the sales floor. The map and store images 10 and 20 may be use to create a three-dimensional model 30 retrievably stored in said database. The present invention may be adapted to project store images onto the three-dimensional model 30, viewable from a virtual viewpoint represented on a user interface 40, whereby a user of the present may traverse said three-dimensional model of the map image 10, interaction with the virtual environment comprising the store images 20.

The present invention may be adapted so that users may create annotations along the map images 10. A location corresponding to the annotation on the map image 10 is determined, and the location is associated with the three-dimensional model. The annotations can be retrievably stored in the database. The annotation can be associated with a plurality of classifications, such as a gender classification, such as “male”, “female”, “family”, or the like. Such annotation could be made to distinguish male, female, and family changing rooms, bathrooms, product space (such as “men's wear”, or even “men's swimwear” within the swimwear department) of the sales floor. The above-disclosed define gender module may be configured to couple to the customer tracking module so that the spent by the electronic device of every customer—through the MAC ID/address or other digital signature of the customer's electronic device—can be tracked and associated in the various annotated portions (gender classified) sales floor, and thereby make a gender determination. Gender is an important parameter used by retailers to forecast future inventory demands.

Inventory items 50 are items associated with tracking data from the inventory tracking module disclosed above. Tracking data may be obtained through scanning a RFID or other machine-readable device that is physically associated with a respective inventory item, whereby the physical location and three-dimensional position of the physically associated inventory item 50 can be identified, located, and tracked as a movable electronic representation along each map image 10. With the combination of the blueprint module and the inventory tracking module, each inventory item 50 physically associated with the store image 20 can be represented on the three-dimensional model, or each such inventory item 50 physically associated with such store image 20 can be compiled, elaborated and/or represented in another format through the user interface.

The present invention may be adapted so that inventory items 50 identified as matching items via the search module pings the blueprint module so that the physical locations of the matching items are displayed on the map image 10.

Aspects of embodiments of the present invention contemplate the use of computer implemented methods, processes, system(s), computer program product and/or devices in enabling the operation of the modules discussed above. The module(s) may be connected with a central server or servers in operation of the system. In an aspect of an embodiment of the present invention, the term “module” may represent self-contained computer hardware. In another aspect of an embodiment of the present invention, the term “module” may represent computer hardware on a designated computer chip or separate computer chips. In yet another aspect of an embodiment of the present invention, the processor may be configured to perform tasks not undertaken by the module(s) disclosed herein. In a further aspect of an embodiment of the present invention, the modules may be hardware resident on one chip, component, separate components, a remote server, database, some or each of which (or all of which, in one aspect of an embodiment of the present invention) may be separate and distinct from the device, or any combination thereof. In one aspect of an embodiment of the present invention, the processor may be configured to coordinate, implement and/or assign tasks to, from and/or among the module(s). In a further aspect of an embodiment of the present invention, “module” may represent operational cooperation between system components. For instance, a “display module” may comprise of the system processor, a display screen, memory, computer executable instructions executable by the processor and resident within memory location(s) etc. with each component being in communication with one or more other components in the module and each component working with the other component(s) to conduct the desired operation for which the module is configured to do e.g. display of content within memory. In a further aspect of an embodiment of the present invention, module components may also, in an operational context, be components of other modules.

In an aspect of an embodiment of the present invention, a central server may coordinate the operations of each individual modules with one another. In another aspect of an embodiment of the present invention, the modules may operate with one another as each operation dictates.

Although this present invention has been disclosed with reference to specific forms and embodiments, it will be evident that a great number of variations may be made without departing from the spirit and scope of the present invention. For example, steps may be reversed, equivalent elements may be substituted for those specifically disclosed and certain features of the present invention may be used independently of other features—all without departing from the present invention as outlined in the appended drawings and claims.

What is claimed is:

1. A method, comprising:
providing one or more computing devices coupled to a database retrievably storing a plurality of inventory items and a map image of one or more three-dimensional sales floors;
each inventory item associated with tracking data for physically locating each inventory item in three-dimensional space;
forming, by a blueprint module of the one or more computing devices, a multi-dimensional model of each sales floor and the physical location of each of the plurality of inventory item circumscribed by each sales floor; and
providing, by the one or more computing devices, a search module for identifying at least one matching item from the plurality of inventory items, wherein the search module prompts the blueprint module to identify the physical location of each of the at least one matching item on each multi-dimensional model.

2. The method of claim 1, wherein the search module prompts the blueprint module only when the computing device providing said search module is within a predetermine distance of the sales floor circumscribing one of matching items.

3. The method of claim 1, wherein the search module provides captured image search functionality.

4. The method of claim 1, wherein the tracking data of each inventory item is generated by a device operative associated with said inventory item.

5. The method of claim 1, wherein each map image further comprises one or more store images, and wherein each store image is a location for one or more inventory item.

6. The method of claim 5, wherein each store image comprises a platform for selling inventory items in three-dimensional space on said sales floor.

7. The method of claim 5, further including, by a virtual reality modality of the one or more computing devices, haptic engagement of each store image so that each store image lists one or more inventory items physically associated therewith upon said store image being engaged via a user interface of a respective computing device.

8. A method, comprising:
providing one or more computing devices coupled to a database retrievably storing a plurality of inventory items and a map image of one or more three-dimensional sales floors;
each inventory item associated with tracking data for physically locating each inventory item in three-dimensional space;
forming, by a blueprint module of the one or more computing devices, a multi-dimensional model of each sales floor and the physical location of each of the plurality of inventory item circumscribed by each sales floor;
providing, by the one or more computing devices, a customer tracking module for identifying the physical location of each computing device on each multi-dimensional model; and
annotating portions of each multi-dimensional model into two or more different classifications for classifying a user of each computing device as a function of the time their respective computing device is physically located within the differently annotated portions.

9. The method of claim 8, wherein the two or more different classifications are gender based so that each user is classified by gender.

10. The method of claim 8, wherein each map image further comprises one or more store images, wherein each store image is a location for one or more inventory item, and wherein each store image is an annotatable portion.

11. The method of claim 10, wherein the store image comprises a changing room.

12. The method of claim 8, wherein identification of said physical location is determined by monitoring the digital signature of each computing device via the customer tracking module.

13. The method of claim 9, wherein each sales floor is segregated into at least one male section annotated portion and at least one female section annotated portion.
